(19) United States
(12) Patent Application Publication
(10) Pub. No.: US 2002/0122986 A1
(43) Pub. Date: Sep. 5, 2002

(54) Lithium battery with separator stored lithium

(76) Inventors: William J. Labarge, Bay City, MI (US); Daniel G. Young, Davison, MI (US)

Correspondence Address: MARGARET A. DOBROWITSKY, DELPHI TECHNOLOGIES, INC., Legal Staff Mail Code: 480-414-420, P.O. Box 5052, Troy, MI, 48007-5052, US

(21) Appl. No.: 09/798,671

(22) Filed: Mar. 2, 2001

(51) Int. Cl. H01M 2/16; H01M 4/58; H01M 4/52; H01M 4/50; H01M 10/40

(52) U.S. Cl. 429/248; 429/231.4; 429/231.1; 429/231.3; 429/223; 429/224; 29/623.2; 429/306

(57) ABSTRACT

A lithium battery having a separator capable of storing excess lithium ions. As lithium ions are irreversibly adsorbed by the battery electrodes, they are replenished from the excess lithium stored in the separator material, thereby extending battery life. In an example of the present invention, molecular sieves, such as 13X molecular sieves, are used as the separator material. Molecular sieves are hydroscopic and therefore also react with moisture in the battery, thereby reducing cell impedance.

### FIELD OF THE INVENTION

This invention relates to a method of preparation of lithium batteries, in particular lithium ion and lithium ion polymer batteries.

### BACKGROUND OF THE INVENTION

Lithium ion cells and batteries are secondary (i.e., rechargeable) energy storage devices well known in the art. The lithium ion cell, known also as a rocking chair type lithium ion battery, typically comprises essentially a carbonaceous anode (negative electrode) that is capable of intercalating lithium ions, a lithium-retentive cathode (positive electrode) that is also capable of intercalating lithium ions, and a non-aqueous, lithium ion conducting electrolyte therebetween.

The carbon anode comprises any of the various types of carbon (e.g., graphite, coke, carbon fiber, etc.) which are capable of reversibly storing lithium species, and which are bonded to an electrically conductive current collector (e.g. copper foil) by means of a suitable organic binder (e.g., polyvinyllidene difluoride, PVDF).

The cathode comprises such materials as transition metal chalcogenides that are bonded to an electrically conductive current collector (e.g., aluminum foil) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂ and LiNiO₂, their solid solutions and/or their combination with other metal oxides.

The electrolyte in such lithium ion cells comprises a lithium salt dissolved in a non-aqueous solvent which may be (1) completely liquid, (2) an immobilized liquid, (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, and polycarbonates, and may be polymerized in situ in the presence of the electrolyte to trap the electrolyte therein as the polymerization occurs. Known polymers for pure polymer electrolyte systems include polyethylene oxide (PEO), polymethylenepolyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer.

Lithium ion and lithium ion polymer cells are often made by laminating thin films of the anode, cathode and electrolyte/separator together wherein the electrolyte/separator is sandwiched between the anode and cathode layers to form an individual cell, and a plurality of such cells are bundled together to form a higher energy/voltage battery.

Lithium cations (Li⁺) are the active component in lithium ion and lithium ion polymer batteries. During the charge process in these lithium ion rechargeable batteries, lithium ions are deintercalated (or released) from the positive electrode and are intercalated (or inserted) into layer planes of the carbonous material. During the discharge, the lithium ions are released from the negative electrode and are inserted into the positive electrode. Only a small amount of electrolyte, such as LiPF₆, is capable of being loaded into the activated cell. Unfortunately, during charging and discharging the battery, some of the Li⁺ ions are irreversibly adsorbed into the anode or cathode materials, making them unavailable for intercalation. There is no means within the cell for replacing the lost Li⁺ ions. This irreversible loss of the active materials is believed to play a role in the slow degradation of lithium batteries.

The neutral part of the battery cell is the separator, for example an SiO₂ separator. An SiO₂ separator has a high surface area, approximately 600 m²/g, and can adsorb a small amount of electrolyte. Lithium ions, however, have no affinity for silica, and as such, less than 0.05 wt. % lithium is associated with the SiO₂. To state it another way, silica contains no ion exchange sites that can adsorb lithium ions into the crystal structure. Given the low initial quantity of lithium ions in the electrolyte/separator, lithium depletion severely limits the calendar life of lithium batteries.

Furthermore, silica is by nature hydrophobic, and unless surface treated with a polymer to render it hydroscopic, it will not react with moisture as moisture is introduced during the making and cycling of the battery. Moisture or water in the battery is a known, practically unavoidable impurity that causes formation of an impedance layer on the anode and cathode. This impedance layer has a blocking effect of lithium intercalation processes on both electrodes. Thus, an increase in cell moisture substantially increases electrode impedance and respectively decreases cell power performance and cell capacity. Battery research is often focused upon reduction of moisture content, yet it continues to be a significant problem with respect to battery performance and lifetime.

There is thus a need to develop a lithium battery that does not suffer from lithium depletion to the extent of current batteries, and which has less moisture during formation and cycling than current batteries.

### SUMMARY OF THE INVENTION

The present invention provides a lithium battery, in particular a lithium ion or lithium ion polymer battery in which the separator comprises a material having ion exchange sites capable of storing lithium ions. The battery cell comprises a transition metal chalcogenide positive electrode and a carbonaceous negative electrode in opposing relation with a separator and lithium ion conducting electrolyte therebetween. When the electrolyte is provided between the electrodes, a quantity of excess lithium ions are adsorbed into the ion exchange sites within the separator material. Upon cycling of the battery, excess lithium ions are released from the separator as lithium ions are irreversibly adsorbed by the electrodes. The separator material further reacts with moisture as it is produced within the battery. There is thus provided a lithium battery and method of manufacturing that addresses the problems of lithium depletion and moisture formation thereby decreasing electrode impedance and respectively increasing cell power performance, cell capacity and calendar life.

### DETAILED DESCRIPTION OF THE INVENTION

The present invention provides a lithium battery that is capable of storing lithium ions within the separator layer between electrodes, which stored lithium can then be used to replenish lithium depleted by irreversible adsorption by the electrodes during battery cycling. To this end, and in accordance with the present invention, a transition metal chalcogenide positive electrode and a carbonaceous negative electrode are assembled in opposing relation with an electrolyte-containing separator therebetween. The separator layer comprises a material having ion exchange sites capable of storing lithium ions. In an example of the present invention, the separator layer comprises a molecular sieve, such as 13X molecular sieves. 13X molecular sieves are so named because they can adsorb 13 wt. % Na₂O. Adjusting for molecular weight, 13X sieves would be able to store approximately 6 wt. % Li⁺. To state this another way, approximately 13 wt. % Na₂O is present in the structure of the 13X molecular sieve, for example, by incorporation from Na present in the precursor materials during synthesis of synthetic molecular sieves, such as zeolite. This Na-zeolite can then be ion exchanged with a Li⁺ cation to make a Li-zeolite product. Through this ion exchange, the Na-zeolite can adsorb about 6 wt. % Li. This extra Li⁺ can be stored into the 13X structure until needed. As Li⁺ is irreversibly adsorbed by the anode and cathode during cycling, it can be replenished from the Li⁺ stored in the separator structure. 13X molecular sieves have a higher surface area of approximately 900 m²/gm as compared to the SiO₂ layers currently used. As a result, the amount of electrolyte in the separator can be increased. Alternatively, the thickness of the separator layer could be decreased from that needed with an SiO₂ material without a decrease in the amount of electrolyte present in the battery.

Molecular sieves are known ceramic materials, typically synthetic zeolites. Zeolites comprise silica and alumina (i.e., aluminosilicates) and depending on the ratio of silica to alumina and other factors will have different pore sizes and different abilities for adsorbing sodium, and therefore lithium ions. Synthetic zeolites are available commercially, for example, under the ZEOLYST™ product name from Zeolyst International, Valley Forge, Pa. Examples of commercially available synthetic zeolites include 3A, 4A and 5A, which have pore sizes of 3, 4 and 5 Å, respectively; and 10X and 13X, which are capable of adsorbing 10 wt. % and 13 wt. % Na₂O, respectively. Thus, “A” is a symbol referring to pore size in angstroms, and “X” is a symbol referring to weight percent Na₂O that can be adsorbed into the zeolite structure. Any molecular sieve capable of storing lithium ions in the crystal structure for use during battery operation are considered to be within the scope of the present invention. 13X molecular sieves at the present time have the largest pore size and greatest ability to adsorb Na₂O and therefore lithium ions.

In addition to the advantage of storing excess lithium ions to combat lithium depletion during battery operation, molecular sieves are hydroscopic by nature, as are the cathode and anode materials. Therefore, they do not require surface treatment to render them hydroscopic. By nature, the molecular sieves can be dried to remove moisture content during battery manufacture, thereby reducing the initial moisture content in the assembled cell. Moreover, the molecular sieves will react with water liberated from components within the battery during cycling. By adsorbing the moisture content, the impedance layer will not form to the extent if higher moisture content were present. Thus, moisture content in the battery and thus cell impedance may be reduced by using a molecular sieve for the separator.

The combination of reduced impedance in the cell and reduced lithium depletion due to the presence of excess stored lithium ions results in a battery with reduced irreversible capacity loss and therefore improved cycle and calendar life, capacity and power capability.

While the present invention has been illustrated by the description of an embodiment thereof, and while the embodiment has been described in considerable detail, it is not intended to restrict or in any way limit the scope of the appended claims to such detail. Additional advantages and modifications will readily appear to those skilled in the art. For example, while 13X synthetic zeolites have been described as particularly useful, the present invention is not limited to synthetic zeolite molecular sieves nor 13X sizes. The invention in its broader aspects is therefore not limited to the specific details, representative apparatus and method and illustrative examples shown and described. Accordingly, departures may be made from such details without departing from the scope or spirit of applicant's general inventive concept.

What is claimed is:

1. A lithium battery comprising a transition metal chalcogenide positive electrode and a carbonaceous negative electrode in opposing relation with a separator and lithium ion conducting electrolyte therebetween, wherein the separator comprises a material having ion exchange sites capable of storing lithium ions.

2. The battery of claim 1, wherein the transition metal chalcogenide is a lithiated manganese oxide.

3. The battery of claim 1, wherein the transition metal chalcogenide is a lithiated cobalt oxide.

4. The battery of claim 1, wherein the transition metal chalcogenide is a lithiated nickel oxide.

5. The battery of claim 1, wherein the carbonaceous electrode comprises graphite.

6. The battery of claim 1, wherein the separator comprises a molecular sieve.

7. The battery of claim 6, wherein the separator comprises a 13X molecular sieve.

8. The battery of claim 6, wherein the separator comprises a molecular sieve capable of storing between about 1 and about 6 wt. % lithium ions.

9. The battery of claim 6, wherein the molecular sieve is a synthetic zeolite.

10. The battery of claim 1, wherein the separator comprises a material capable of storing between about 1 and about 6 wt. % lithium ions.

11. The battery of claim 1, wherein the electrolyte comprises a polymer.

12. A lithium battery comprising a lithiated transition metal oxide positive electrode and a carbonaceous negative electrode in opposing relation with a separator and lithium ion conducting polymer electrolyte therebetween, wherein the separator comprises a molecular sieve having ion exchange sites capable of storing lithium ions.

13. The battery of claim 12, wherein the separator comprises a 13X molecular sieve.

14. The battery of claim 12, wherein the separator comprises a molecular sieve capable of storing between about 1 and about 6 wt. % lithium ions.

15. The battery of claim 12, wherein the molecular sieve is a synthetic zeolite.

16. A method for manufacturing a lithium battery comprising:
providing a cell having a transition metal chalcogenide positive electrode, a carbonaceous negative electrode and a separator therebetween, wherein the separator comprises a material having ion exchange sites capable of storing excess lithium ions;
providing a lithium ion conducting electrolyte between the positive and negative electrodes, wherein a quantity of excess lithium ions are adsorbed into the ion exchange sites; and
sealing in a container one or more cells to form a battery, wherein upon cycling of the battery, excess lithium ions are released from the separator as lithium ions are irreversibly adsorbed by the electrodes.

17. The method of claim 16, wherein the separator comprises a molecular sieve.

18. The method of claim 17, wherein the separator comprises a 13X molecular sieve.

19. The method of claim 17, wherein the separator comprises a molecular sieve capable of storing between about 1 and about 6 wt. % excess lithium ions.

20. The method of claim 17, wherein the molecular sieve is a synthetic zeolite.

21. The method of claim 16, wherein the separator comprises a material capable of storing between about 1 and about 6 wt. % excess lithium ions.

22. A method for manufacturing a lithium battery comprising:
providing a cell having a lithiated transition metal oxide positive electrode, a carbonaceous negative electrode and a separator therebetween, wherein the separator comprises a molecular sieve having ion exchange sites capable of storing excess lithium ions;
providing a lithium ion conducting polymer electrolyte between the positive and negative electrodes, wherein a quantity of excess lithium ions are adsorbed into the ion exchange sites; and
sealing in a container one or more cells to form a battery, wherein upon cycling of the battery, excess lithium ions are released from the separator as lithium ions are irreversibly adsorbed by the electrodes.

23. The method of claim 22, wherein the separator comprises a 13X molecular sieve.

24. The method of claim 22, wherein the separator comprises a molecular sieve capable of storing between about 1 and about 6 wt. % excess lithium ions.

25. The method of claim 22, wherein the molecular sieve is a synthetic zeolite.
